(19) United States
(12) Patent Application Publication
(10) Pub. No.: US 2012/0307659 A1
(43) Pub. Date: Dec. 6, 2012

(54) NETWORK SYSTEM, GATEWAY DEVICE AND METHOD OF DETERMINING A FORWARDING PATH

(75) Inventor: Daisuke YAMADA, Nagoya-shi (JP)

(73) Assignee: BUFFALO, INC., Nagoya-shi (JP)

(21) Appl. No.: 13/483,576

(22) Filed: May 30, 2012

(30) Foreign Application Priority Data
May 31, 2011 (JP) 2011-121240

(51) Int. Cl. H04W 40/00; H04L 12/56; H04W 24/00; H04W 84/12

(52) U.S. Cl. 370/252; 370/338

(57) ABSTRACT

A network system for forwarding a packet includes a portable network connection device that includes a first communication controller and is connectable with a client. A gateway device is included that has a second communication controller and performs routing. The portable network connection device and the gateway device are connected by a first network including a tunnel path. When the portable network connection device and the gateway device are connected by a second network that does not include the tunnel path, the second communication controller communicates with the first communication controller via the second network. When the portable network connection device and the gateway device are not connected by the second network, the second communication controller communicates with the first communication controller via the first network.

### CROSS-REFERENCE TO RELATED APPLICATION

This application claims priority under 35 U.S.C. §119 to Japanese Patent Application No. 2011-121240 filed on May 31, 2011, which is hereby incorporated by reference in its entirety and for all purposes.

### BACKGROUND

1. Technical Field

This disclosure relates to relaying packets in a communication network.

2. Related Art

A wireless LAN access point (hereinafter also called “access point”) is widely used to connect a wireless LAN client (hereinafter also called “client”), such as personal computer or game machine, to a network. Connecting the access point with a gateway device enables the client to access the Internet via the access point and the gateway device. The gateway device may be provided, for example, as a home gateway by an ISP (Internet Service Provider).

Various portable and transportable devices have been proposed for the access point. One of such devices is a portable network connection device having a functional block to make wireless communication via a mobile communication network such as a 3G/HSPA (High Speed Packet Access) line, in addition to the functions of the access point. The portable network connection device allows the user to connect a personal computer to the Internet via a network, which is different from the network to which the gateway device belongs to. More specifically, when the user takes out the personal computer and the portable network connection device, for example, from the house to the outside, the personal computer serving as the client and the portable network connection device serving as the access point allows data transmission from the personal computer to the portable network connection device. Additionally, the portable network connection device serving as the router enables the data received from the personal computer to be sent from the portable network connection device to the Internet via the mobile communication network.

When the portable network connection device is taken out to the different network from the network, to which the gateway device belongs, the device serving as the gateway for connecting the personal computer to the Internet is changed from the gateway device to the portable network connection device. An address (global IP address) assigned to the gateway device is generally different from an address (global IP address) assigned to the portable network connection device. When the portable network connection device is taken out with continuing data transmission between the personal computer and a server connected with the Internet, the session established between the personal computer and the server is shut down to interrupt the data transmission between the server and the personal computer. The user is accordingly required to reestablish the session between the personal computer and the server after the portable network connection device is moved to a different location.

This problem, as recognized by the present inventor, is not limited to the case where the portable network connection device is moved from the network, to which the gateway device belongs, to another network but is also found in the case where the portable network connection device is moved (returned) from another network to the network, to which the gateway device belongs.

### SUMMARY

Consequently, there is a need to prevent a session via a portable network connection device from being shut down when the portable network connection device is moved between a network, to which a gateway device belongs, and another network.

According to one exemplary embodiment, a network system for forwarding a packet, includes:

a portable network connection device that includes a first communication controller and is connectable with a client; and

a gateway device that includes a second communication controller and performs routing, wherein

the portable network connection device and the gateway device are connected by a first network including a tunnel path, wherein

when the portable network connection device and the gateway device are connected by a second network that does not include the tunnel path, the second communication controller communicates with the first communication controller via the second network, and

when the portable network connection device and the gateway device are not connected by the second network, the second communication controller communicates with the first communication controller via the first network.

According to another embodiment, a gateway device that performs routing and is connectable with a portable network connection device, includes:

an interface for a first network configured to connect with the first network including a tunnel path provided as a route through which a packet encapsulated with a header including a different destination address and a different source address different from a destination address and a source address specified by a source of the packet is forwarded;

an interface for a second network configured to connect with the second network that does not include the tunnel path;

an interface for a third network configured to connect with the third network that does not include the tunnel path and is different from the second network;

a detector that detects a presence or an absence of the portable network connection device in the second network;

a path determiner that determines a forwarding path to forward a packet, wherein
when the detector detects the presence of the portable network connection device in the second network, the path determiner determines a path from the third network to the second network as a forwarding path to forward a packet from the third network to a client connected with the portable network connection device, while determining a path from the second network to the third network as a forwarding path to forward a packet from the client to the third network, and
when the detector detects the absence of the portable network connection device in the second network, the path determiner determines a path from the third network to the first network as the forwarding path to forward a packet from the third network to the client;

a packet transfer controller configured to forward a packet through the determined path; and

an encapsulator configured to encapsulate a packet.

According to another embodiment, a method of determining a forwarding path to forward a packet in a gateway device that performs routing and is connectable with a portable network connection device, wherein

the gateway device belongs to a first network, a second network and a third network wherein the first network includes a tunnel path provided as a route through which a packet encapsulated with a header including a different destination address and a different source address different from a destination address and a source address specified by a source of the packet is forwarded, the second network does not include the tunnel path, and the third network does not include the tunnel path and is different from the second network,

the method comprising:

detecting a presence or an absence of the portable network connection device in the second network;

when the presence of the portable network connection device in the second network is detected in the detecting, determining a path from the third network to the second network as a forwarding path to forward a packet from the third network to a client connected with the portable network connection device, while determining a path from the second network to the third network as a forwarding path to forward a packet from the client to the third network,

when the absence of the portable network connection device in the second network is detected in the detecting, determining a path from the third network to the first network as the forwarding path to forward a packet from the third network to the client.

### BRIEF DESCRIPTION OF THE DRAWINGS

FIG. 1 illustrates the schematic configuration of a network system 10 including a portable network connection device 100 according to one embodiment of the invention;

FIG. 2 illustrates a second connection configuration of the network system 10;

FIG. 3 illustrates a third connection configuration of the network system 10;

FIG. 4 illustrates the detailed structure of the portable network connection device 100 and the cradle 200;

FIG. 5 illustrates one example of the settings of the routing table RT3 shown in FIG. 4;

FIG. 6 illustrates the detailed structure of the gateway device 500;

FIG. 7 illustrates one example of the settings of the first routing table RT1 shown in FIG. 6;

FIG. 8 illustrates one example of the settings of the second routing table RT2 shown in FIG. 6;

FIG. 9 is a flowchart showing the procedure of operation mode changeover process performed by the portable network connection device 100;

FIG. 10 is a flowchart showing the procedure of packet forwarding path determination process performed by the gateway device 50;

FIG. 11 schematically illustrates data transmission between the client and the server in the first connection configuration; and

FIG. 12 schematically illustrates the data transmission between the client and the server in the second connection configuration.

### DESCRIPTION OF EMBODIMENTS

### A. Embodiment

### A1. System Configuration

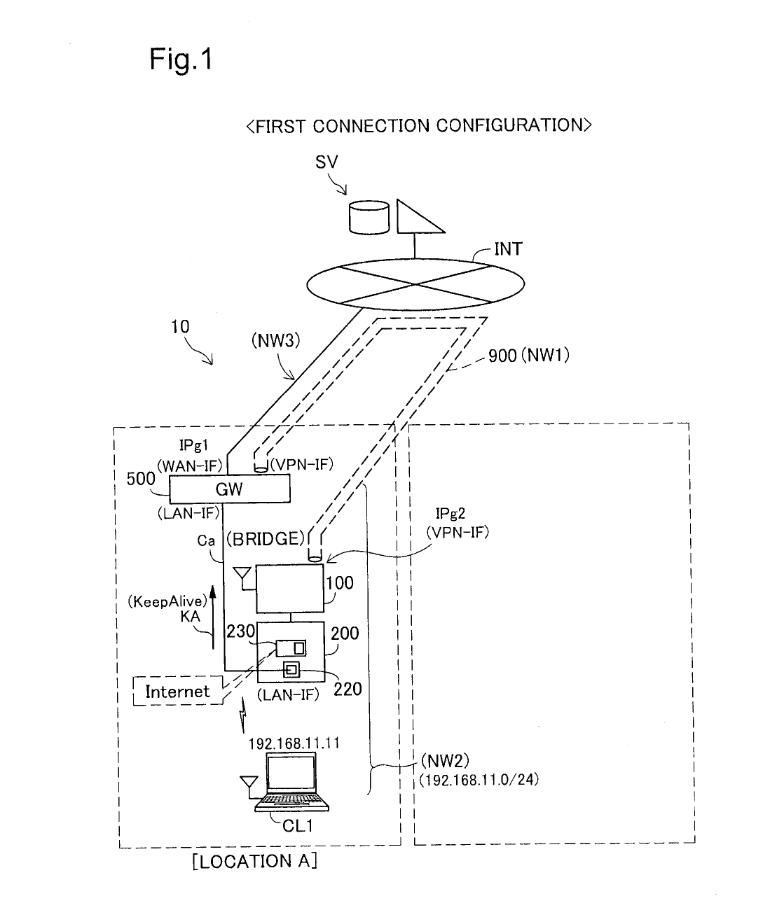

FIG. 1 illustrates the schematic configuration of a network system 10 including a portable network connection device 100 according to one embodiment of the disclosure. The network system 10 includes a gateway device 500, the portable network connection device 100, a cradle 200, a client CL1 and a tunnel path 900. The network system 10 serves to forward packets (layer 3 packets) sent from the client CL1 via the Internet INT and to forward packets destined for client CL1 to the client CL1. The client CL1 is accordingly allowed to send a data download request to a server SV connected to the Internet INT and to download data from the server SV.

The gateway device 500 is a stationary device working as the router and is connected to the Internet INT via a network NW3 including an access line (i.e., line provided by a common carrier). The gateway device 500 is connected with the cradle 200 by way of a network cable Ca. The gateway device 500 has an interface LAN-IF (Local Area Network-Interface) for connecting with a LAN (wired LAN or wireless LAN), an interface WAN-IF (Wide Area Network-Interface) for connecting with the access line (network NW3), and an interface VPN-IF (Virtual Private Network-Interface) for connecting with the tunnel path 900. A global IP address “IPg1” is assigned to the interface WAN-IF. A device provided as the home gateway by an ISP (Internet Service Provider) may be employed for the gateway device 500. The detailed structure of the gateway device 500 will be described later.

The cradle 200 is configured to be connectable with the portable network connection device 100 and has the function as a base structure for holding the portable network connection device 100 mounted thereon, the function for relaying power to the portable network connection device 100, and the function for connecting the portable network connection device 100 with a wired LAN. The cradle 200 has a port 220 and a changeover switch 230. The port 220 is used to connect the cradle 200 with the wired LAN and is connected with the network cable Ca as shown in FIG. 1. The changeover switch 230 is a slide switch for changeover between the functions of the port 220.

The portable network connection device 100 is a small, lightweight portable device serving to relay packets (frames) on layer 3 as an OSI (Open Systems Interconnection) model network layer or on layer 2 as a data link layer. The portable network connection device 100 is connectable with the cradle 200 in a freely attachable/detachable manner. In the state of FIG. 1, the portable network connection device 100 is connected with the cradle 200.

The portable network connection device 100 has two operation modes for packet forwarding process. More specifically, the portable network connection device 100 has a first operation mode for relaying packets on layer 2 (i.e., operation mode working as the bridge) and a second operation mode for relaying packets on layer 3 (i.e., operation mode working as the router). In the illustrated state of FIG. 1, the portable network connection device 100 works in the first operation mode (i.e., as the bridge). Here the term “router” means the function of relaying packets on layer 3 and more specifically the function of relaying packets between different networks (i.e., different broadcast domains). The term “bridge” means the function of relaying packets (frames) on layer 2 and more specifically the function of relaying packets (frames) in one single network (i.e., single broadcast domain).

The portable network connection device 100 has an interface LAN-IF for connecting with a LAN (wired LAN or wireless LAN) and an interface VPN-IF for connecting with the tunnel path 900 (network NW1). A global IP address “IPg2” is assigned to the interface VPN-IF of the portable network connection device 100. The detailed structure of the portable network connection device 100 having the interfaces LAN-IF and VPN-IF will be described later.

According to this embodiment, the client CL1 is a personal computer. The client CL1 has a wireless LAN interface and is connected with the portable network connection device 100 via the wireless LAN interface. In the state of FIG. 1, the client CL1 serves as the wireless LAN client. The portable network connection device 100 works both as the router and as the wireless LAN access point.

The tunnel path 900 is a packet forwarding path established between the gateway device 500 and the portable network connection device 100 through the Internet INT. The tunnel path 900 may be established by a mobile communication network and a network NW1 including an access line for connecting the gateway device 500 with the Internet INT. The tunnel path 900 is provided as the route, along which a packet (layer 3 packet) as a forwarding object encapsulated with a header including a different destination IP address and a different source IP address different from a destination IP address and a source IP address specified by a source of the packet is forwarded. According to this embodiment, the known network VPN provided by the ISP provider or by the common carrier may be used for the tunnel path 900. In the tunnel path 900, an IP packet to be transmitted between the gateway device 500 and the portable network connection device 100 is encrypted to prevent intercept by any third person. According to this embodiment, IPSec (Internet Protocol Security or Security Architecture of Internet Protocol) specified by IETF (Internet Engineering Task Force) is used as the encryption protocol.

The network system 10 allows a plurality of connection configurations among its constituents. FIG. 1 shows a first connection configuration of the network system 10. In the first connection configuration, all the constituents are provided at one identical location A (e.g., house or office). In the first connection configuration, the portable network connection device 100 is directly connected to the interface LAN-IF of the gateway device 500 via the cradle 200 by way of the network cable Ca. In the specification hereof, the term “directly connected” means “connected by wired or by wireless along a route without the tunnel path 900”. In the first connection configuration, the client CIA is connected with the interface LAN-IF of the portable network connection device 100 by wireless. As mentioned previously, in the first connection configuration, the portable network connection device 100 works in the first operation mode. In the first connection configuration, one network NW2 is established in the downstream of the gateway device 500 (i.e., on the side farther away from the Internet INT). Private network addresses “192.168.11.0/24” are assigned to the network NW2. A private IP address “192.168.11.11” is assigned to the client CIA belonging to the network NW2. The gateway device 500 has address conversion function for converting between the global IP address (IPg1) and the private IP address (e.g., 192.168.11.10). The NAT (Network Address Translation) function or the NAPT (Network Address Port Translation) function may be employed for the address conversion function.

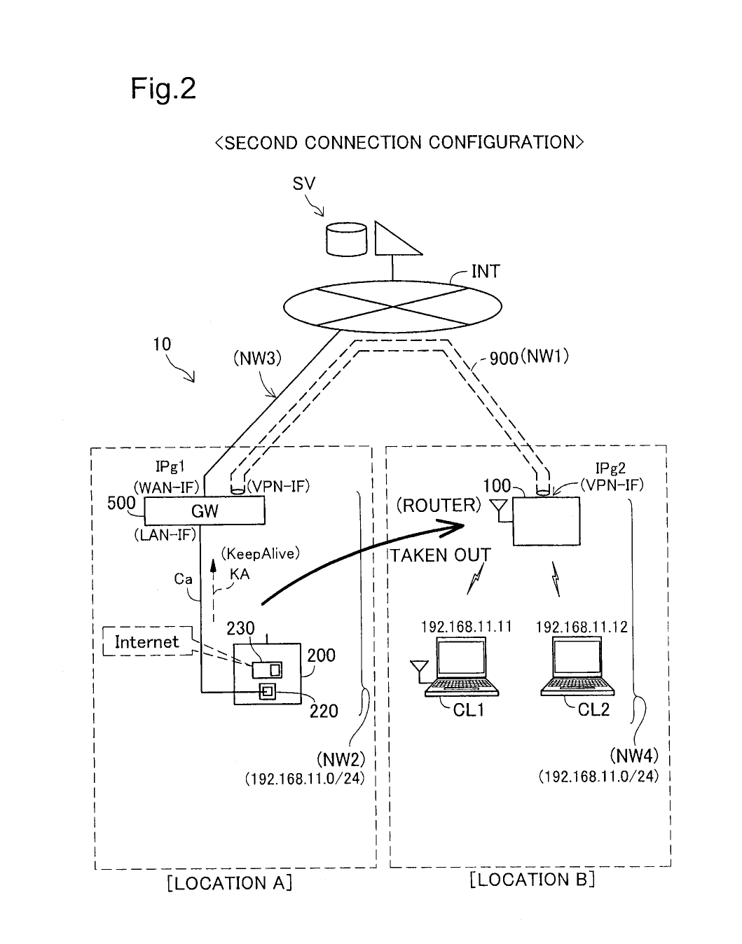

FIG. 2 illustrates a second connection configuration of the network system 10. In the second network configuration, all the constituents are not provided at one identical location. More specifically, the gateway device 500, the cradle 200, and the network cable Ca are provided at a location A shown in the left half of FIG. 2. The portable network connection device 100, the client CL1 and another client CL2 are provided at a location B shown in the right half of FIG. 2. In the second connection configuration, the location A and the location B are significantly remote from each other, such that communication between a wireless LAN access point at one location and a wireless LAN client at the other location is not allowed. The portable network connection device 100 is thus not directly connectable with the interface LAN-IF of the gateway device 500.

The client CL2 is a personal computer like the client CL1 and has a wireless LAN interface. The client CL2 is connected with the portable network connection device 100 via the wireless LAN interface. A network NW4 with assignment of private network addresses 192.168.11.0/24 is established at the location B. A private IP address “192.168.11.12” is assigned to the client CL2.

The portable network connection device 100 also has a mobile communication interface and establishes wireless communication with a mobile communication base station via the mobile communication interface. In the state of FIG. 2, the portable network connection device 100 works as the router to forward packets from the client CL1 or the client CL2 to the Internet INT and packets from the Internet INT to the client CL1 or the client CL2.

In communication of each of the two clients CL1 and CL2 via the internet INT, the portable network connection device 100 encapsulates the private IP address of the client CL1 or the client CL2 with the global IP address (IPg2).

The first connection configuration of FIG. 1 at the location A may be changed to the second connection configuration of FIG. 2, for example, when the user detaches the portable network connection device 100 from the cradle 200, takes out the portable network connection device 100 and the client CL1 to the location B, and connects the new client CL2 by wireless with the portable network connection device 100 working as the wireless LAN access point. The user may take out the portable network connection device 100 and the client CL1 from the location A, for example, when the user intends to move to the location B with continuing data transmission between the client CIA and the server SV. Such data transmission between the client CL1 and the server SV may be, for example, stream transmission of videos output from the server SV or file transfer from the server SV.

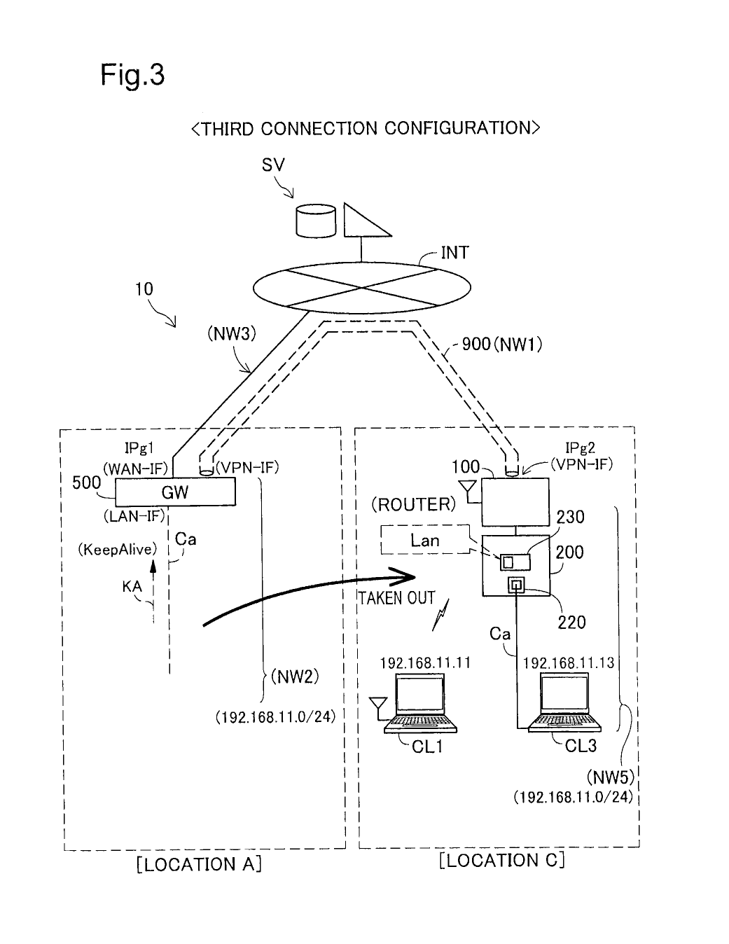

FIG. 3 illustrates a third connection configuration of the network system 10. The third connection configuration of FIG. 3 is similar to the second connection configuration of FIG. 2, except that the cradle 200 and the network cable Ca are additionally taken out from the location A and are moved to another location C and that a client CL3 is connected with the cradle 200 by wired. In the third connection configuration, the location A and the location C are significantly remote from each other, such that communication between a wireless LAN access point at one location and a wireless LAN client at the other location is not allowed. The portable network connection device 100 is thus not directly connectable with the interface LAN-IF of the gateway device 500. The network cable Ca at the location A may be different from the network cable Ca at the location C.

The client CL3 is a personal computer like the client CL1 and has a wired LAN interface. The client CL3 is connected with the cradle 200 via the wired LAN interface and the network cable Ca. A network NW5 with assignment of private network addresses 192.168.11.0/24 is established at the location C. A private IP address “192.168.11.13” is assigned to the client CL3.

The first connection configuration of FIG. 1 at the location A may be changed to the third connection configuration of FIG. 3, for example, when the user takes out the portable network connection device 100 and the client CL1 to the location C and connects the new client CL3 by wire with the portable network connection device 100, in order to construct a new network at the location C.

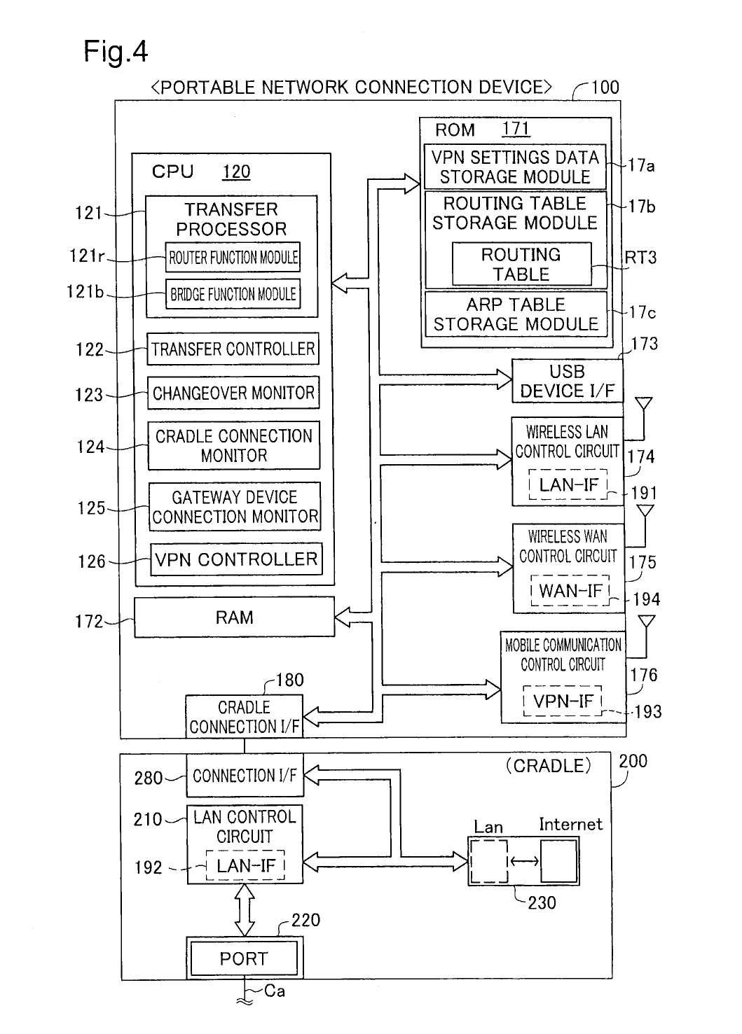

FIG. 4 illustrates the detailed structure of the portable network connection device 100 and the cradle 200. The cradle 200 includes a connection interface (I/F) 280 and a LAN control circuit 210, in addition to the port 220 and the changeover switch 230 described above. The port 220 and the LAN control circuit 210 are interconnected by an internal bus. Similarly, the LAN control circuit 210 and the connection interface 280 are interconnected by an internal bus.

The port 220 may be, for example, a port conforming to the IEEE802.3/3u/3ab standard. The LAN control circuit 210 controls data transmission via the port 220 according to a predetermined network protocol (for example, Ethernet®). The LAN control circuit 210 has an interface LAN-IF 192. The interface LAN-IF 192 is a logical interface provided in the LAN control circuit 210 and is used for data transmission via a wired LAN.

The changeover switch 230 is manually changed over between an “Internet” position and a “Lan” position. In the illustrated state of FIG. 4, the changeover switch 230 is set to the “Internet” position. The port 220 serves as the port for connecting with the client at the “Lan” position of the changeover switch 230, while serving as the port for connecting with the gateway device 500 at the “Internet” position of the changeover switch 230.

The connection interface 280 has the functions of a USB (Universal Serial Bus) device controller and serves to transmit information to and from the portable network connection device 100 according to the USB standards when the cradle 200 is connected with the portable network connection device 100.

The portable network connection device 100 includes a USB device interface 173, a wireless LAN control circuit 174, a wireless WAN control circuit 175, a mobile communication control circuit 176, a cradle connection interface (I/F) 180 for connecting with the cradle 200, a CPU (Central Processing Unit) 120, a ROM (Read Only Memory) 171 and a RAM (Random Access Memory) 172. The USB device interface 173 is used for connecting with a USB (Universal Serial Bus) device (e.g., storage device).

The wireless LAN control circuit (also called “wireless LAN interface”) 174 includes a modulator, an amplifier and an antenna and serves as a wireless LAN access point conforming to, for example, the IEEE802.11b/g standard to establish wireless communication with a wireless LAN client (e.g., personal computer or game machine). The wireless LAN control circuit 174 has an interface LAN-IF 191. The interface LAN-IF 191 is a logical interface provided in the wireless LAN control circuit 174 and is used for data transmission via a wireless LAN.

The wireless WAN control circuit (also called “wireless WAN interface”) 175 includes a modulator, an amplifier and an antenna and serves as a wireless LAN client conforming to, for example, the IEEE802.11a/b/g standard to establish wireless communication with a wireless LAN access point (e.g., public wireless LAN access point). The wireless WAN control circuit 175 has an interface WAN-IF 194. The interface WAN-IF 194 is a logical interface provided in the wireless WAN control circuit 175 and is used for data transmission, for example, via a public wireless LAN.

The mobile communication control circuit (also called “mobile communication interface”) 176 includes a modulator, an amplifier and an antenna and serves as a mobile communication terminal conforming to, for example, the 3G/HSPA protocol to establish wireless communication with a mobile communication base station. The mobile communication control circuit 176 has an interface VPN-IF 193. The interface VPN-IF 193 is a logical interface provided in the mobile communication control circuit 176 and is used for data transmission via the VPN (tunnel path 900). As described, the portable network connection device 100 of the first embodiment has a plurality of wireless communication interfaces for making wireless communication in different wireless communication networks.

The cradle connection interface 180 has the functions of a USB host controller and serves to transmit information to and from the cradle 200 according to the USB standards when the portable network connection device 100 is connected with the cradle 200. The cradle connection interface 180 also serves to feed the power supplied from the cradle 200 via the connection interface 280 to a battery provided in the portable network connection device 100 when the portable network connection device 100 is connected with the cradle 200.

The CPU 120 loads and executes the firmware and computer programs stored in the ROM 171 onto the RAM 172, so as to control the respective components of the portable network connection device 100 and to serve as a transfer processor 121, a transfer controller 122, a changeover monitor 123, a cradle connection monitor 124, a gateway device connection monitor 125 and a VPN controller 126. The CPU 120 corresponds to the first communication controller according to the claims.

The transfer processor 121 has a router function module 121r and a bridge function module 121b and serves to forward packets (layer 3 packets and layer 2 packets) via the respective wireless communication interfaces (wireless LAN control circuit 174, wireless WAN control circuit 175 and mobile communication control circuit 176) and the port 220. The transfer processor 121 has a first operation mode, in which only the bridge function 121b performs processing, and a second operation mode, in which both the bridge function module 121b and the router function module 121r perform processing, as available operation modes for packet forwarding. In the first operation mode, only the bridge function module 121b serves to forward layer 2 frames, so that the portable network connection device 100 and the cradle 200 work as the bridge as a whole. In the second operation mode, on the other hand, both the bridge function module 121b and the router function module 121r perform processing, so that the portable network connection device 100 and the cradle 200 work as the router as a whole.

The transfer controller 122 controls the transfer processor 121. As one of such controls, the transfer controller 122 performs an operation mode changeover process (described later) to set or change the operation mode of the transfer processor 121.

The changeover monitor 123 monitors the setting of the changeover switch 230. More specifically, for example, the changeover switch 230 is connected with a GPIO (General Purpose Input/Output) port of the CPU 120 by a control line, and the changeover monitor 123 may monitor an interrupt signal input into the CPU 120 via the control line, so as to monitor the setting of the changeover switch 230. The changeover monitor 123 continuously monitors a change in setting of the changeover switch 230 (i.e., any operation) after the portable network connection device 100 is powered on.

The cradle connection monitor 124 is the functional block to monitor whether the portable network connection device 100 is connected with the cradle 200. More specifically, for example, the cradle connection monitor 124 may monitor the power feeding between the cradle connection interface 180 and the connection interface 280, so as to monitor the connection between the portable network connection device 100 and the cradle 200. In another example, the cradle connection monitor 124 may monitor the connection between the portable network connection device 100 and the cradle 200 by an inter-device connection detection sequence according to the USB standards. The inter-device connection detection sequence may detect the connection between the portable network connection device 100 and the cradle 200, for example, when one of USB signal lines, i.e., either a D+ signal line or a D− signal line has the voltage level of 3.3 V. The cradle connection monitor 124 continuously monitors the connection between the portable network connection device 100 and the cradle 200 after the portable network connection device 100 is powered on.

The gateway device connection monitor 125 monitors whether the portable network connection device 100 is connected with the gateway device 500 and outputs a signal to notify the gateway device 500 of the presence of the portable network connection device 100 (i.e., keep-alive signal KA shown in FIG. 1). Monitoring “whether the portable network connection device 100 is connected with the gateway device 500” herein means whether the gateway device 500 belongs to the same network, which the portable network connection device 100 belongs to. For example, the gateway device connection monitor 125 may register in advance the address of the gateway device 500 and output the keep-alive signal KA to the registered address by unicast. In another example, the gateway device connection monitor 125 may output the keep-alive signal KA by broadcast within the same network, which the portable network connection device 100 belongs to.

The VPN controller 126 controls data transmission via the tunnel path 900. More specifically, the VPN controller 126 performs the process for establishing the tunnel path 900, for example, authentication and transmission of an encryption key, encryption and decryption accompanied with data transmission via the tunnel path 900, and data compression and data decompression. The VPN controller 126 performs the process for establishing the tunnel path 900 (such as authentication) at regular intervals, in cooperation with a functional block at the other end of the tunnel path 900 (i.e., VPN controller of the gateway device 500 described later), after the start-up of the portable network connection device 100. The tunnel path 900 is thus continuously established after the start-up of the gateway device 500 and the portable network connection device 100.

The ROM 171 is a writable non-volatile memory. The ROM 171 includes a VPN settings data storage module 17a, a routing table storage module 17b and an ARP table storage module 17c, in addition to the programs for the respective functional blocks described above. The VPN settings data storage module 17a stores various data for forming the VPN. More specifically, the VPN settings data storage module 17a may store, for example, an encryption key used for authentication with a device connected via the VPN (tunnel path 900), a tunnel IP address (“IPg2” shown in FIGS. 1 and 2) and data indicating whether data to be transmitted to and from the connected device are to be compressed.

The routing table storage module 17b stores a routing table RT3. The routing table RT3 is referred to by the transfer processor 121 (router function module 121r) when the portable network connection device 100 works as the router.

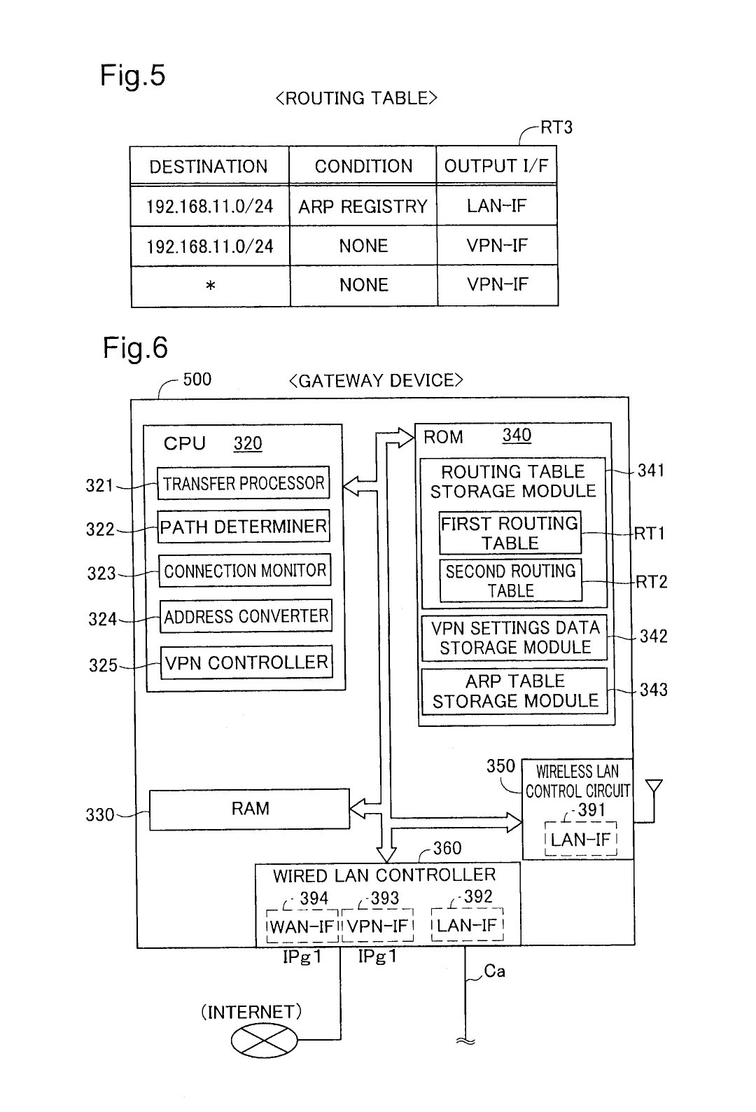

FIG. 5 illustrates one example of the settings of the routing table RT3 shown in FIG. 4. The routing table RT3 correlates the destination address to the condition and the output interface (I/F). The destination address represents a destination address of a packet to be forwarded. The condition represents a prerequisite for application of the corresponding entry. The output I/F represents an output destination interface of the packet to be forwarded.

In the illustrated example of FIG. 5, the routing table RT3 has registry of three entries. The top entry has the destination “192.168.11.0/24”, the condition “ARP registry” and the output I/F “LAN-IF”. This entry indicates that packets having the destination addresses registered in an ARP table among the packets having the destination network addresses of “192.168.11.0/24” are to be output from the output interface LAN-IF. The middle entry has the destination “192.168.11.0/24”, the condition “none” and the output I/F “VPN-IF”. This entry indicates that the packets having the destination network addresses of “192.168.11.0/24” are unconditionally to be output from the output interface VPN-IF. The bottom entry has the destination “*”, the condition “none” and the output I/F “VPN-IF”. This entry indicates that the packets having any destination addresses are unconditionally to be output from the output interface VPN-IF. The user may connect a terminal used for settings (e.g., personal computer) with the portable network connection device 100 and manually set the registration of these three entries. The routing table RT3 is referred to or searched in the sequence of the top entry, the middle entry and the bottom entry until any matching entry is found.

Referring back to FIG. 4, the ARP table storage module 17c stores the ARP table. The ARP table correlates the IP address to the MAC (Media Access Control) address, and an entry is learnt and added to the ARP table on every occasion of communication with the client. An entry is learnt and registered with respect to the client within the same network (i.e., the same broadcast domain), which the portable network connection device 100 belongs to. No entry is, however, registered with respect to the client in a different network from the network, which the portable network connection device 100 belongs to.

FIG. 6 illustrates the detailed structure of the gateway device 500. The gateway device 500 includes a CPU 320, a RAM 330, a ROM 340, a wireless LAN control circuit 350 and a wired LAN controller 360.

The CPU 320 loads and executes computer programs stored in the ROM 340 onto the RAM 330 to serve as a transfer processor 321, a path determiner 322, a connection monitor 323, an address converter 324 and a VPN controller 325. The CPU 320 corresponds to the second communication controller according to the claims.

The transfer processor 321 forwards an IP packet input via the wired LAN controller 360 or the wireless LAN control circuit 350. The path determiner 322 determines the forwarding path of the input packet. The connection monitor 323 monitors whether the portable network connection device 100 belongs to the same network, which the gateway device 500 belongs to. More specifically, the connection monitor 323 determines that the portable network connection device 100 belongs to the same network, which the gateway device 500 belongs to, when receiving the keep-alive signal KA (explained above) within a predetermined period of time, while determining that the portable network connection device 100 does not belong to the same network, which the gateway device 500 belongs to, when not receiving the keep-alive signal KA (explained above) within the predetermined period of time. The address converter 324 makes conversion between the global IP address and the private IP address. The VPN controller 325 has the same functions as those of the VPN controller 126 of the portable network connection device 100 shown in FIG. 4.

The ROM 340 is a writable non-volatile memory. The ROM 340 includes a routing table storage module 341, a VPN settings data storage module 342 and an ARP table storage module 343, in addition to the programs for the respective functional blocks described above. The routing table storage module 341 stores a first routing table RT1 and a second routing table RT2. The user may connect a terminal used for settings (e.g., personal computer) with the gateway device 500 and manually set these two routing tables RT1 and RT2.

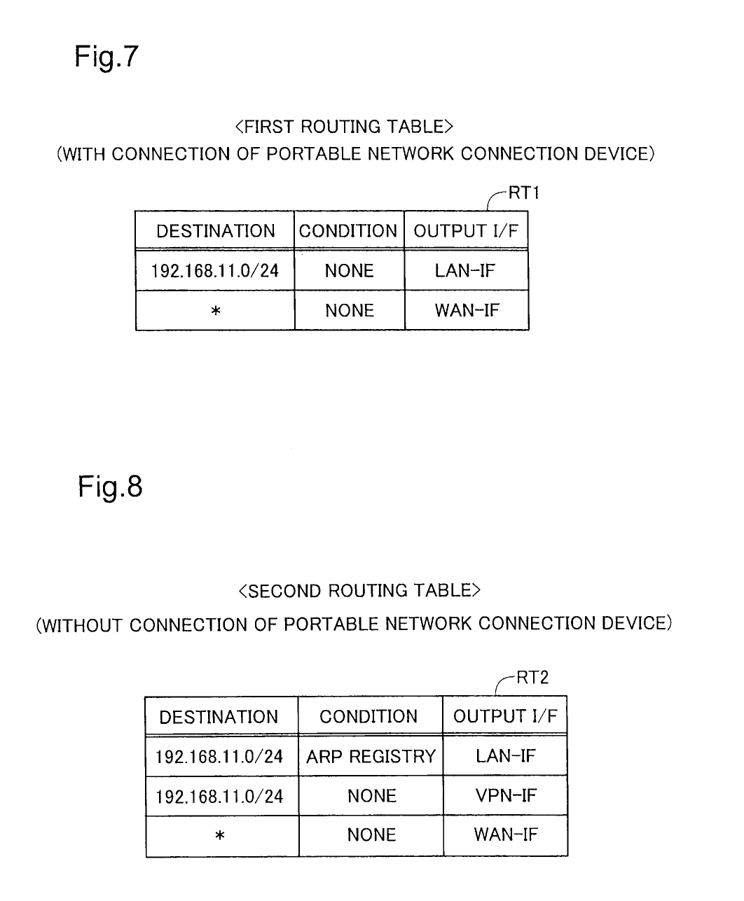

FIG. 7 illustrates one example of the settings of the first routing table RT1 shown in FIG. 6. Like the routing table RT3 shown in FIG. 5, the first routing table RT1 correlates the destination address to the condition and the output interface (I/F).

In the illustrated example of FIG. 7, the first routing table RT1 has registry of two entries. The upper entry has the destination “192.168.11.0/24”, the condition “none” and the output I/F “LAN-IF”. This entry indicates that the packets having the destination network addresses of “192.168.11.0/24” are unconditionally to be output from the output interface LAN-IF. The lower entry has the destination “*”, the condition “none” and the output I/F “WAN-IF”. This entry indicates that the packets having any destination addresses are unconditionally to be output from the output interface WAN-IF. As in the case of the routing table RT3 shown in FIG. 5, the routing table RT1 is referred to in the sequence of the upper entry and the lower entry.

FIG. 8 illustrates one example of the settings of the second routing table RT2 shown in FIG. 6. Like the routing table RT3 and the first routing table RT1, the second routing table RT2 correlates the destination address to the condition and the output interface (I/F).

In the illustrated example of FIG. 8, the second routing table RT2 has registry of three entries. The top entry has the destination “192.168.11.0/24”, the condition “ARP registry” and the output I/F “LAN-IF”. This entry is identical with the top entry of the routing table RT3 shown in FIG. 5, although the output destination shown by the interface “LAN-IF” in the second routing table RT2 is different from that in the routing table RT3 of FIG. 5. The middle entry has the destination “192.168.11.0/24”, the condition “none” and the output I/F “VPN-IF”. This entry is identical with the middle entry of the routing table RT3 shown in FIG. 5, although the output destination shown by the interface “VPN-IF” in the second routing table RT2 is different from that in the routing table RT3 of FIG. 5. The bottom entry has the destination “*”, the condition “none” and the output I/F “WAN-IF”. This entry indicates that the packets having any destination addresses are unconditionally to be output from the output interface WAN-IF. As in the case of the routing table RT3 and the first routing table RT1, the second routing table RT2 is referred to in the sequence of the top entry, the middle entry and the bottom entry.

The VPN settings data storage module 342 shown in FIG. 6 has the same functions as those of the VPN settings data storage module 17a of the portable network connection device 100 shown in FIG. 4. The ARP table storage module 343 has the same functions as those of the ARP table storage module 17c of the portable network connection device 100 shown in FIG. 4.

The wireless LAN control circuit 350 has the same functions as the wireless LAN control circuit 174 of the portable network connection device 100 shown in FIG. 4. The wireless LAN control circuit 350 has an interface LAN-IF 391. The interface LAN-IF 391 has the same functions as those of the interface LAN-IF 191 included in the portable network connection device 100 shown in FIG. 4.

The wired LAN controller 360 has the same functions as those of the LAN control circuit 210 and the port 220 shown in FIG. 4. The wired LAN controller 360 has interfaces LAN-IF 392, VPN-IF 393 and WAN-IF 394. The interface LAN-IF 392 has the same functions as those of the interface LAN-IF 391. The interface VPN-IF 393 has the same functions as those of the interface VPN-IF 193 included in the portable network connection device 100 shown in FIG. 4. The interface WAN-IF 394 is used for data transmission via a WAN (the Internet INT). A global IP address “IPg1” is assigned to both the interfaces WAN-IF 394 and VPN-IF 393.

In the network system 10, the portable network connection device 100 performs the operation mode changeover process described below and works as the bridge when the portable network connection device 100 belongs to the same network as that of the gateway device 500, while working as the router when the portable network connection device 100 belongs to a different network from that of the gateway device 500. In the network system 10, the gateway device 500 performs a packet forwarding path determination process described later, in order to prevent the session from being shut down when the client CL1 is moved from the location A to the location B with continuing communication with the server SV.

The network NW1, the network NW2 and the network NW3 respectively correspond to the first network, the second network and the third network according to the claims. The interface VPN-IF 193, the transfer processor 121 and the VPN controller 126 respectively correspond to the first network interface, the first packet transfer processor and the first encapsulator according to the claims. The interface WAN-IF 394 corresponds to the third network interface or the interface for the third network according to the claims. The interface VPN-IF 393 corresponds to the fourth network interface or the interface for the first network according to the claims. The interfaces LAN-IF 391 and LAN-IF 392 correspond to the fifth network interface or the interface for the second network according to the claims. The connection monitor 323 corresponds to the detector according to the claims. The transfer processor 321 corresponds to the second packet transfer processor or the packet transfer processor according to the claims. The VPN controller 325 corresponds to the second encapsulator or the calculating module according to the claims. The first routing table RT1 and the second routing table RT2 respectively correspond to the first routing table and the second routing table according to the claims. The gateway device connection monitor 125 corresponds to the notice packet transmitter according to the claims.

### A2. Operation Mode Changeover Process

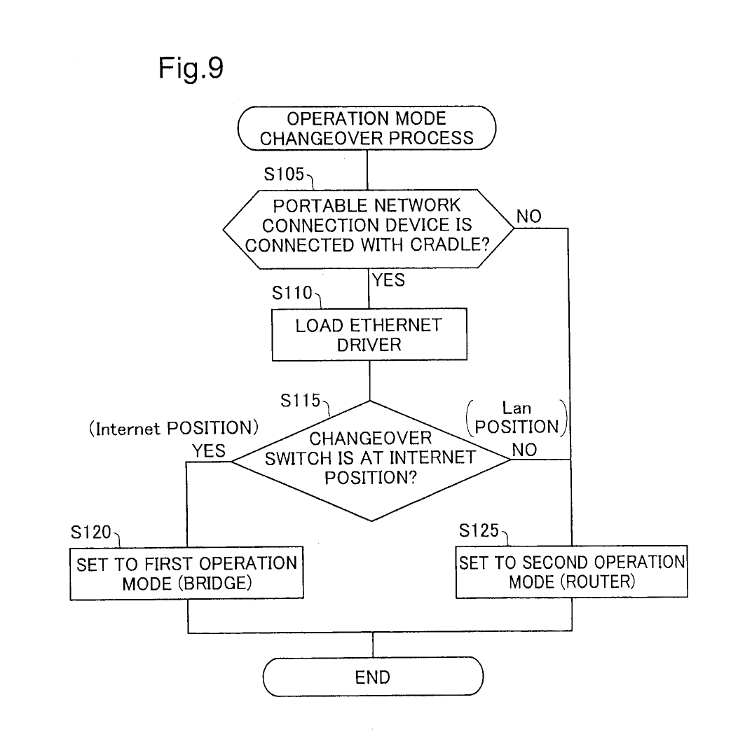

FIG. 9 is a flowchart showing the procedure of operation mode changeover process performed by the portable network connection device 100. The portable network connection device 100 performs the operation mode changeover process when there is a change in connection between the portable network connection device 100 and the cradle 200 or when there is a change in setting of the changeover switch 230. The operation mode of the portable network connection device 100 (transfer processor 121) is set to the “first operation mode (bridge)” as the initial setting when the portable network connection device 100 is powered on.

The transfer controller 122 controls the connection monitor 124 and determines whether the portable network connection device 100 is connected with the cradle 200 (step S105). When the portable network connection device 100 is connected with the cradle 200 (step S105: Yes), the transfer controller 122 loads and executes an Ethernet®driver program stored in the ROM 171 onto the RAM 172, so as to make the LAN control circuit 210 included in the cradle 200 ready for operation (step S110).

The transfer controller 122 controls the changeover monitor 123 and determines whether the changeover switch 230 is set at the “Internet” position (step S115). When the changeover switch 230 is set at the “Internet” position (step S115: Yes), the transfer controller 122 sets or changes the operation mode of the transfer processor 121 to the first operation mode (step S120). When the changeover switch 230 is set at the “Lan” position (step S115: No), on the other hand, the transfer controller 122 sets or changes the operation mode of the transfer processor 121 to the second operation mode (step S125).

When the portable network connection device 100 is connected with the cradle 200 (step S105: Yes) and the changeover switch 230 is set at the “Internet” position (step S115: Yes), it is estimated that the gateway device 500 is connected with the portable network connection device 100 via the cradle 200 (i.e., first connection configuration). In this state, the gateway device 500 works as the router, so that the portable network connection device 100 is set to work in the first operation mode to serve as the bridge. Such setting advantageously prevents communication error with the client CL1 via the Internet INT, due to the simultaneous presence of multiple devices (gateways) serving as the router in the same network.

When the portable network connection device 100 is connected with the cradle 200 (step S105: Yes) and the changeover switch 230 is set at the “Lan” position (step S115: No), on the other hand, it is estimated that a client is connected with the cradle 200 and that the portable network connection device 100 is not connected with the gateway device 500 (i.e., third connection configuration). In this state, there is no device functioning as the router in the network, which the portable network connection device 100 belongs to, so that the portable network connection device 100 (transfer processor 121) is set to work in the second operation mode to serve as the router. Such setting advantageously prevents communication error with the client CL1 via the Internet INT, due to the absence of any device (gateway) functioning as the router in the network, which the portable network connection device 100 belongs to.

When it is determined that the portable network connection device 100 is not connected with the cradle 200 (step S105: No), the transfer controller 122 sets the operation mode of the transfer processor 121 to the second operation mode (step S125).

When the portable network connection device 100 is not connected with the cradle 200, it is estimated that the portable network connection device 100 is not connected with the gateway device 500 and that a client is connected with the portable network connection device 100 by a wireless LAN (i.e., second connection configuration. In this state, there is no device functioning as the router in the network which the client belongs to, so that the portable network connection device 100 (transfer processor 121) is set to work in the second operation mode to serve as the router. When it is determined that the portable network connection device 100 is not connected with the cradle 200, the Ethernet driver program is not loaded. This advantageously reduces the processing load of the CPU 120 and thereby reduces the power consumption of the battery.

### A3. Packet Forwarding Path Determination Process

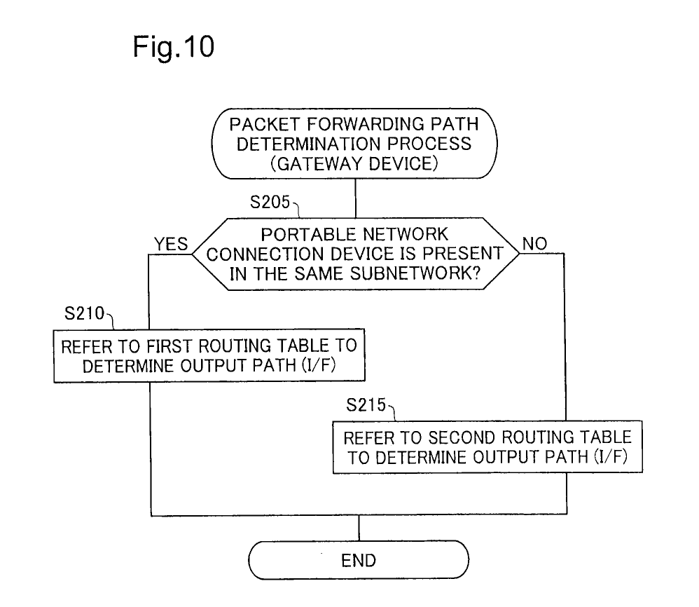

FIG. 10 is a flowchart showing the procedure of packet forwarding path determination process performed by the gateway device 500. The gateway device 500 performs the packet forwarding path determination process when a packet to be forwarded reaches the gateway device 500.

The path determiner 322 controls the connection monitor 323 and determines whether the portable network connection device 100 is present in the same network, which the gateway device 500 belongs to (i.e., network NW2) (step S205). When it is determined that the portable network device 100 is present in the same network, which the gateway device 500 belongs to (step S205: Yes), the path determiner 322 refers to the first routing table RT1 and determines the path (output interface) based on the destination address of the packet to be forwarded (step S210).

When it is determined that the portable network device 100 is not present in the same network which the gateway device 500 belongs to (step S205: No), on the other hand, the path determiner 322 refers to the second routing table RT2 and determines the path (output interface) based on the destination address of the packet to be forwarded (step S215). When the output interface of the packet is determined by this packet forwarding path determination process, the transfer processor 321 of the gateway device 500 forwards the packet to the determined output interface.

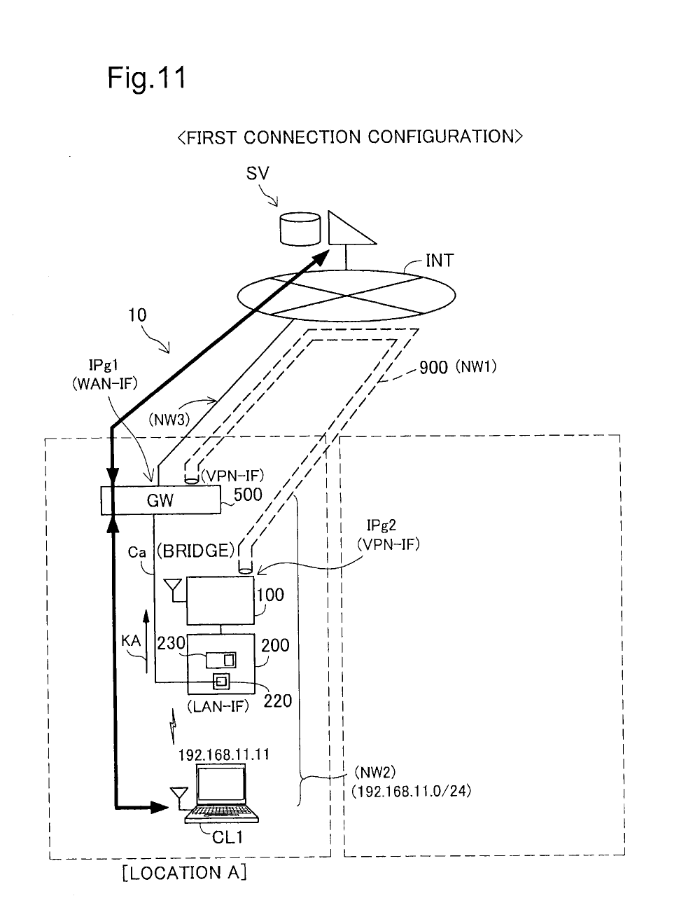

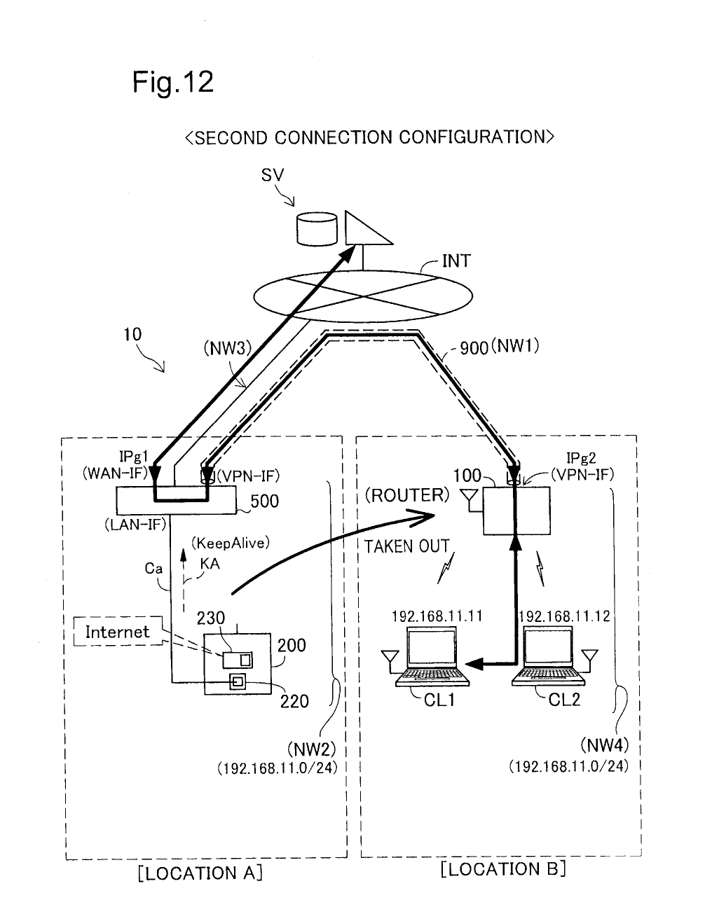

FIG. 11 schematically illustrates data transmission between the client and the server in the first connection configuration. FIG. 12 schematically illustrates the data transmission between the client and the server in the second connection configuration.

As shown in FIG. 11, in the first connection configuration, a packet from the client CL1 to the server SV is received by the gateway device 500 via the portable network connection device 100, and the gateway device 500 determines the path of the received packet. The portable network connection device 100 works as the bridge, so that the IP packet is not terminated.

In the first connection configuration shown in FIG. 11, the keep-alive signal KA output from the portable network connection device 100 is receivable by the gateway device 500, so that the path of the packet from the client CL1 to the server SV is determined by referring to the first routing table RT1. More specifically, the destination address of the packet is the IP address of the server SV, and the lower entry in the first routing table RT1 of FIG. 7 is accordingly found as the matching entry, which specifies the interface WAN-IF (i.e., WAN-IF 394 shown in FIG. 6) as the output interface of the packet. The gateway device 500 then changes the source IP address of the packet from “192.168.11.11” to “IPg1”.

In the first connection configuration, a packet from the server SV to the client CL1 is received by the gateway device 500, and the gateway device 500 changes the destination address of the received packet from “IPg1” to “192.168.11.11” and determines the path of the received packet. In this case, the first routing table RT1 is also used to determine the packet path. In the first connection configuration, the client CL1 belongs to the same network NW2, which the gateway device 500 belongs to, so that the ARP table of the gateway device 500 has registry of an entry regarding the client CL1. The destination address of the packet is “192.168.11.11”, and the upper entry in the first routing table RT1 of FIG. 7 is accordingly found as the matching entry, which specifies the interface LAN-IF (i.e., LAN-IF 391 and LAN-IF 392 shown in FIG. 6) as the output interface of the packet. The packet then reaches the client CL1 through the portable network connection device 100 working as the bridge.

When the portable network connection device 100 and the client CL1 are taken out to the location B with continuing data transmission between the client CL1 and the server SV, the first connection configuration is changed to the second connection configuration shown in FIG. 12.

When the portable network connection device 100 is detached from the cradle 200, the operation mode changeover process shown in FIG. 9 determines that the portable network connection device 100 is not connected with the cradle 200 (step S105: No) and sets the operation mode of the portable network connection device 100 to the second mode to serve as the router (step S125).

In the second connection configuration shown in FIG. 12, a packet from the client CL1 to the server SV is received by the portable network connection device 100 working as the router, and the portable network connection device 100 determines the path of the received packet. The destination address of the packet is the IP address of the server SV, and the bottom entry in the routing table RT3 of FIG. 5 is accordingly found as the matching entry, which specifies the interface VPN-IF (i.e., VPN-IF 193 shown in FIG. 4) as the output interface of the packet. The packet then reaches the interface VPN-IF 393 of the gateway device 500 through the tunnel path 900.

When receiving the packet at the interface VPN-IF 393, the gateway device 500 determines the path of the received packet. In the second connection configuration shown in FIG. 12, the keep-alive signal KA output from the portable network connection device 100 does not reach the gateway device 500. The path of the packet received through the tunnel path 900 (i.e., VPN-IF 393) is thus determined by referring to the second routing table RT2. More specifically, the destination address of the packet is the IP address of the server SV, and the bottom entry in the second routing table RT2 of FIG. 8 is accordingly found as the matching entry, which specifies the interface WAN-IF (i.e., WAN-IF 394 shown in FIG. 6) as the output interface of the packet. As in the case of the first connection configuration, the gateway device 500 then changes the source IP address of the packet from “192.168.11.11” to “IPg1”.

In the second connection configuration, a packet from the server SV to the client CL1 is received by the gateway device 500, and the gateway device 500 changes the destination address of the received packet from “IPg1” to “192.168.11.11” and determines the path of the received packet.

In this case, the second routing table RT2 is also used to determine the packet path. In the second connection configuration, the client CL1 belongs to the different network (network NW4) from the network (network NW2), which the gateway device 500 belongs to, so that the ARP table of the gateway device 500 does not have registry of an entry regarding the client CL1. The destination address of the packet is “192.168.11.11”, and the middle entry in the second routing table RT2 of FIG. 8 is accordingly found as the matching entry, which specifies the interface VPN-IF (i.e., VPN-IF 393 shown in FIG. 6) as the output interface of the packet. The packet then reaches the interface VPN-IF 193 of the portable network connection device 100 through the tunnel path 900.

When receiving a packet at the interface VPN-IF 193, the portable network connection device 100 determines the path of the packet. In the second connection configuration, the client CL1 belongs to the same network (network NW4), which the portable network connection device 100 belongs to, so that the ARP table of the portable network connection device 100 has registry of an entry regarding the client CL1. The destination address of the packet to the client CL1 is “192.168.11.11”, and the top entry in the routing table RT3 of FIG. 5 is accordingly found as the matching entry, which specifies the interface LAN-IF (i.e., LAN-IF 191 and LAN-IF 192 shown in FIG. 4) as the output interface of the packet. The packet then reaches the client CL1 through the portable network connection device 100 working as the bridge (access point).

In both the first connection configuration shown in FIG. 11 and the second connection configuration shown in FIG. 12, the gateway device 500 works as the device (gateway) receiving the packet from the server SV to the client CL1. In other words, in both the first connection configuration shown in FIG. 11 and the second connection configuration shown in FIG. 12, the destination IP address (global IP address) of the packet from the server SV to the client CL1 is “IPg1” assigned to the interface WAN-IF 394 of the gateway device 500. Even when the first connection configuration is changed to the second connection configuration by taking out the client CL1 and the portable network connection device 100 from the location A with continuing data transmission between the client CL1 and the server SV, the session between the server SV and the client CL1 is not shut down, since there is no change in IP address of the gateway in the network system 10.

When the second connection configuration of FIG. 12 is changed to the first connection configuration of FIG. 11 by returning the portable network connection device 100 and the client CL1 to the location A, the gateway device 500 refers to the first routing table RT1 to determine the forwarding path of the packet from the server SV to the client CL1. The packet accordingly reaches the client CL1.

As described above, in the network system 10 according to the embodiment, the gateway device 500 is connected with the portable network connection device 100 by means of the tunnel path 900. When the portable network connection device 100 does not belong to the same network (network NW2), which the gateway device 500 belongs to, the gateway device 500 refers to the second routing table RT2 having the entry for forwarding the packet through the tunnel path 900, as the routing table to forward the packet to the client CL1. Irrespective of the change from the first connection configuration to the second connection configuration, the packet from the server SV to the client CL1 (i.e., the packet having the destination IP address of “IPg1”) can thus reach the client CL1.

When the portable network connection device 100 belongs to the same network, which the gateway device 500 belongs to, on the other hand, the gateway device 500 refers to the first routing table RT1 having the entry for forwarding the packet via the interfaces LAN-IF 191 and LAN-IF 192, as the routing table to forward the packet to the client CIA. Irrespective of the change from the second connection configuration to the first connection configuration, the packet from the server SV to the client CL1 (i.e., the packet having the destination IP address of “IPg1”) can thus reach the client CL1. As clearly understood from the foregoing, the network system 10 of the embodiment advantageously prevents the session between the client CL1 and the server SV from being shut down, when the portable network connection device 100 is moved from the same network NW2, which the gateway device 500 belongs to, to the different network NW4 and when the portable network connection device 100 is moved from the different network NW4 to the same network NW2, which the gateway device 500 belongs to. The user is accordingly not required to reestablish the session between the client CL1 and the server SV, irrespective of the change between the first connection configuration and the second connection configuration. Despite of the change in location of the portable network connection device 100 and the client CL1, streaming data, such as video data and audio data distributed from the sever SV, can be reproduced by the client CL1 without interruption. This also prevents file forwarding between the server SV and the client CL1 from being interrupted by a location change.

### B. Modifications

The disclosure is not limited to the above embodiment or its applications, but a multiplicity of variations and modifications may be made to the embodiment without departing from the scope of the disclosure. Some examples of possible modification are given below.

### B1. Modification 1

The tunnel path using IPSec as the encryption protocol is employed for the tunnel path 900 according to the above embodiment, but the disclosure is not limited to this encryption protocol. The tunnel path 900 may be a tunnel path using PPTP (Point to Point Tunneling Protocol) or a tunnel path provided by Mobile IP specified by IETF. In the configuration adopting the tunnel path provided by Mobile IP, the gateway device 500 has a functional block serving as a home agent (HA), the portable network connection device 100 has a functional block serving as a foreign agent (FA), and the client CL1 preferably has a functional block serving as a mobile node (MN). In the configuration adopting the tunnel path provided by Mobile IP, a packet from the server SV to the client CL1 is received by the gateway device 500 serving as the home agent and is forwarded to the portable network connection device through the tunnel path. A packet from the client CL1 to the server SV is, however, directly sent from the client CL1 to the server SV. In this configuration, the client CL1 has a path connecting to the Internet INT without the portable network connection device, such as mobile communication network. A packet from the client CL1 as the source to the server SV as the destination is not received by the gateway device 500, so that the path determiner 322 of the gateway device 500 does not determine the path of the packet from the client CL1 to the server SV.

In general, the network system according to the disclosure has the path determiner configured to determine the path from the network NW3 to the tunnel path 900 (network NW1), as the forwarding path of the packet from the network NW3 (i.e., server SV) to the client CL1, when the portable network connection device 100 does not belong to the same network NW2, which the gateway device 500 belongs to.

### B2. Modification 2

According to the above embodiment, whenever receiving a packet to be forwarded, the gateway device 500 performs the packet forwarding path determination process to select the routing table to be used for determination of the forwarding path and determine the output interface by referring to the selected routing table; the invention is, however, not limited to this embodiment. According to another embodiment, selection of the routing table to be used for determination of the forwarding path may be performed at a different timing from the timing of determination of the forwarding path (output interface). More specifically, selection of the routing table to be used for determination of the forwarding path may be performed at regular intervals, irrespective of reception or no reception of any packet to be forwarded, while determination of the forwarding path (output interface) may be performed whenever a packet to be forwarded is received in the same manner as the above embodiment. This alternative embodiment does not require selection of the routing table whenever a packet to be forwarded is received, thus advantageously shortening the time required for forwarding the packet.

### B3. Modification 3

According to the above embodiment, the gateway device 500 provides the different two routing tables RT1 and RT2, in order to change the packet forwarding path, based on the presence or the absence of the portable network connection device 100 in the same network NW2, which the gateway device 500 belongs to; the invention is, however, not limited to this embodiment. According to another embodiment, the gateway device 500 may provide only one routing table, which may be rewritten when the connection configuration is changed from the presence of the portable network connection device 100 in the same network NW2 to the absence of the portable network connection device 100 or when the connection configuration is changed from the absence of the portable network connection device 100 in the same network NW2 to the presence of the portable network connection device 100. More specifically, when the connection configuration is changed from the presence of the portable network connection device 100 in the same network NW2 to the absence of the portable network connection device 100, the routing table is rewritten from the settings shown in FIG. 7 to the settings shown in FIG. 8. When the connection configuration is changed from the absence of the portable network connection device 100 in the same network NW2 to the presence of the portable network connection device 100, on the other hand, the routing table is rewritten from the settings shown in FIG. 8 to the settings shown in FIG. 7.

### B4. Modification 4

Although the keep-alive signal KA is output only from the portable network connection device 100 according to the above embodiment, the keep-alive signal KA may be output from both the portable network connection device 100 and the gateway device 500 according to another embodiment. According to this alternative embodiment, the portable network connection device 100 can identify the presence or the absence of the gateway device 500 in the same network, based on reception or no reception of the keep-alive signal output from the gateway device 500. This advantageously simplifies the procedure of operation mode changeover process. More specifically, the portable network connection device 100 sets the first operation mode when receiving the keep-alive signal output from the gateway device 500, and sets the second operation mode when not receiving the keep-alive signal. This ensures accurate detection whether the gateway device 500 is present or absent in the same network, which the portable network connection device 100 belongs to.

VRRP (Virtual Router Redundancy Protocol) may be employed in the embodiment that both the portable network connection device 100 and the gateway device 500 output the keep-alive signal. More specifically, both the portable network connection device 100 and the gateway device 500 may be configured to be VRRP-compatible and cooperatively form a virtual router. According to the VRRP protocol, devices forming a virtual router mutually send keep-alive signals (VRRP advertisements) at regular intervals and determine which device should serve as a master router and which device should serve as a backup router, based on the received VRRP advertisements. The portable network connection device 100 and the gateway device 500 can thus identify the presence or the absence of the other device in the same network, which one device belongs to, at regular intervals by utilizing the keep-alive signals mutually set at regular intervals. In this configuration, each of the portable network connection device 100 and the gateway device 500 can use the functional block of sending a packet representing the VRRP advertisement message as the functional block of sending a packet notifying the other device of its own presence. This advantageously simplifies the structures of the portable network connection device 100 and the gateway device 500 and reduces the manufacturing cost of the portable network connection device 100 and the gateway device 500.

### B5. Modification 5

The gateway device 500 has the function of converting between the global IP address and the private IP address (address converter 324) according to the above embodiment, but this function may be omitted as appropriate. For example, when a global IP address is assigned to each of the constituents or the devices constituting the network system 10, the address conversion function may be omitted. In another example, when a private IP address is assigned to each of the constituents or the devices in the network system 10 including the tunnel path, the address conversion function may be omitted.

### B6. Modification 6

According to the above embodiment, the portable network connection device 100 (transfer processor 121) changes the operation mode, based on the connection or disconnection between the portable network connection device 100 and the cradle 200 and the setting of the changeover switch 230. Modification 4 described above changes the operation mode, based on the reception or no reception of the keep-alive signal output from the gateway device 500. The invention is, however, not limited to this embodiment or modification. According to another embodiment, the operation mode may be determined, based on the reception or no reception of any signal other than the keep-alive signal output from the gateway device 500. More specifically, for example, when the gateway device 500 has DHCP (Dynamic Host Configuration Protocol) server function, the operation mode may be determined, based on the reception or no reception of a DHCPOFFER message or DHCPACK message representing the presence of the DHCP server. In this configuration, the portable network connection device 100 is structured to send a DHCPDISCOVER message for searching the DHCP server. In another example, when the gateway device 500 has PPPoE (PPP over Ethernet®) server function, the operation mode may be determined, based on the reception or no reception of a PADO (PPPoE Active Discovery Offer) message representing the presence of the PPPoE server. In this configuration, the portable network connection device 100 is structured to send a PADI (PPPoE Active Discovery Initiation) message for searching the PPPoE server. In another example, when the gateway device 500 serves as an IGD (Internet Gateway Device) according to UPnP (Universal Plug and Play), the operation mode may be determined, based on the reception or no reception of IGD advertisement representing the presence of the IGD.

### B7. Modification 7

According to the above embodiment, the gateway device 500 identifies whether the portable network connection device 100 is present or absent in the same network (network NW2), based on the keep-alive signal output from the portable network connection device 100; the invention is, however, not limited to this embodiment. According to another embodiment, the gateway device 500 may send a reply request message at regular intervals and identify whether the portable network device 100 is present or absent in the same network (network NW2), based on the reception or no reception of a reply message responding to the reply request message. An example of the reply request message is a PING (Packet INternet Grouper) packet. According to another embodiment, the cradle 200 may have a functional block configured to detect the connection or disconnection between the portable network connection device 100 and the cradle 200 and notify the gateway device 500 of the detected connection or disconnection. In this configuration, the gateway device 500 may identify whether the portable network device 100 is present or absent in the same network (network NW2), based on the information on the connection or disconnection notified by the cradle 200.

### B8. Modification 8

The portable network connection device 100 and the gateway device 500 are connected by wired in the first connection configuration according to the above embodiment, but can be connected by wireless according to another embodiment. For example, the gateway device 500 works as a wireless LAN access point, whereas the portable network connection device 100 works as a wireless LAN client. According to this alternative embodiment, the portable network connection device 100 may set the operation mode, based on the reception or no reception of beacon output from the gateway device 500. For example, the portable network connection device 100 can set the first operation mode with a change in reception status from no reception of beacon to reception of beacon and set the second operation mode with a change from reception of beacon to no reception of beacon.

### B9. Modification 9

According to the above embodiment, the tunnel path 900 is continuously established after the start-up of the gateway device 500 and the portable network connection device 100; the invention is, however, not limited to this embodiment. According to another embodiment, when the gateway device 500 or the portable network connection device 100 determines the tunnel path 900 as the forwarding path of a packet to be forwarded (i.e., when the interface VPN-IF 393 or the interface VPN-IF 193 is specified as the output interface), the tunnel path 900 can be established. In this configuration, there is a possibility that the received packet is discarded by the gateway device 500 or by the portable network connection device 100 before the tunnel path 900 is established. In this case, however, the packet is re-forwarded after establishment of the tunnel path 900 to normally reach the destination. This configuration also effectively prevents the session between the client CL1 and the server SV from being shut down. This alternative embodiment does not require the processing (e.g., authentication) for establishing the tunnel path 900 by the VPN controller 126 of the portable network connection device 100 and the VPN controller 325 of the gateway device 500 at regular intervals, thus saving the consumption of the resources, such as the CPUs 320 and 120.

### B10. Modification 10

The structures of the gateway device 500 and the portable network connection device 100 described in the above embodiment are only illustrative and may be changed, altered and modified in various ways. For example, the cradle connection interface 180 of the portable network connection device 100 and the connection interface 280 of the cradle 200 transmit information in conformity to the USB standards according to the above embodiment, but information may be transmitted between the portable network connection device 100 and the cradle 200 in conformity with any standards other than the USB standards. The portable network connection device 100 and the cradle 200 are provided as separate constituents according to the above embodiment, but may be integrated according to another embodiment.

According to another embodiment, the wireless LAN control circuits 350 and 174 and the wireless WAN control circuit 175 may be constructed as wireless communication interfaces configured to make wireless communication by the wireless LAN conforming to the IEEE802.11a/b/g standard, as well as any future available wireless LAN. The mobile communication control circuit 176 may be constructed as a wireless communication interface configured to make wireless communication by mobile communication conforming to the 3G/HSPA protocol, as well as any future available mobile communication, such as LTE, newt-generation mobile WiMAX (IEEE802.16m) or next-generation PHS (XGP: eXtended Global Platform).

The gateway device 500 has wired connection to the Internet INT (network NW3) by means of the wireless LAN controller 360 according to the above embodiment, but may have wireless connection to the Internet INT according to another embodiment. For example, the gateway device 500 may additionally have a mobile communication control circuit like the portable network connection device 100 and use the mobile communication control circuit to make connection to the Internet INT via a mobile communication network.

The portable network connection device 100 includes the three different types of wireless communication interfaces, i.e., wireless LAN control circuit 174, wireless WAN control circuit 175 and mobile communication control circuit 176 according to the above embodiment, but can include only one or two of these three different types of wireless communication interfaces or can include four or more different types of wireless communication interfaces according to other embodiments. The portable network connection device 100 can include a plurality of the same type of wireless communication interfaces. The disclosure is not limited to the wireless LAN or mobile communication but is generally applicable to wireless communication in any suitable wireless communication network. The number of constituents included in the network system 10 is not limited to the number described in any of the above embodiment and its modifications. For example, the network system may include any number of portable network connection devices. In another example, the network system may include any number of clients at each of the locations A, B and C.

According to another embodiment, part of the hardware configuration may be replaced by the software configuration, and, in an opposite manner, part of the software configuration may be replaced by the hardware configuration. When part or all of the functions according to the disclosure is implemented by the software configuration, the software (computer programs) may be provided in the form of storage in a computer readable storage medium. The “computer readable storage medium” herein is not limited to portable storage media, such as flexible disks and CD-ROMs but includes internal storage devices, such as various RAMs and ROMs, incorporated in the computer and external storage devices, such as hard disk drive, attached to the computer. The term “computer readable storage medium” is accordingly used in the wider sense to represent any non-transitory storage medium.

Each of the clients CIA to CL3 is not limited to the personal computer as described in the above embodiment but may be any of various other devices connectable with a network, for example, game machine, FDA (Personal Digital. Assistance), cell phone, portable music player or table terminal.

The foregoing has described the disclosure in detail with reference to the illustrative embodiment. The disclosure is, however, not restricted to the embodiment or the configuration described above. The disclosure includes various modifications and equivalents. Additionally, although various elements of the disclosure are described in diverse combinations and structures, these are only illustrative, and the number of each element may be increased, decreased or even one. Any of such modifications should also be embraced in the scope of claims.

### C. Other Aspects

According to an aspect of a network system for forwarding a packet, includes:

a portable network connection device that includes a first communication controller and is connectable with a client; and

a gateway device that includes a second communication controller and performs routing, wherein

the portable network connection device and the gateway device are connected by a first network including a tunnel path, wherein

when the portable network connection device and the gateway device are connected by a second network that does not include the tunnel path, the second communication controller communicates with the first communication controller via the second network, and

when the portable network connection device and the gateway device are not connected by the second network, the second communication controller communicates with the first communication controller via the first network.

In the network system according to the first aspect of the network system, the portable network connection device and the gateway device are connected by the first network including the tunnel path. This advantageously prevents a session established via the portable network connection device and the gateway device from being shut down, even when the portable network connection device is moved between the network, which the gateway device belongs to, and another network.

According to the aspect of network system, the tunnel path is provided as a route through which a packet encapsulated with a header including a different destination address and a different source address different from a destination address and a source address specified by a source of the packet is forwarded,

the portable network connection device further includes:
a first network interface being connectable with the first network; and
a second network interface being connectable with the second network,

the first communication controller includes:
a first packet transfer processor configured to work as a bridge when the portable network connection device belongs to the second network, and to work as a router when the portable network connection device does not belong to the second network; and
a first encapsulator configured to encapsulate a packet, the gateway device further includes:
a third network interface being connectable with a third network that does not include the tunnel path and is different from the second network;
a fourth network interface being connectable with the first network; and
a fifth network interface being connectable with the second network,

the second communication controller includes:
a detector that detects a presence or an absence of the portable network connection device in the second network;
a path determiner that determines a forwarding path to forward a packet, wherein when the detector detects the presence of the portable network connection device in the second network, the path determiner determines a path from the third network to the second network as a forwarding path to forward a packet from the third network to the client, while determining a path from the second network to the third network as a forwarding path to forward a packet from the client to the third network, and wherein when the detector detects the absence of the portable network connection device in the second network, the path determiner determines a path from the third network to the first network as the forwarding path to forward a packet from the third network to the client;
a second packet transfer controller configured to forward a packet along the determined path; and
a second encapsulator configured to encapsulate a packet.

The network system according to this aspect determines the path from the third network to the second network as the forwarding path to forward a packet from the third network to the client on detection of the presence of the portable network connection device in the second network, while determining the path from the third network to the first network as the forwarding path to forward a packet from the third network to the client on detection of the absence of the portable network connection device in the second network. This enables at least a packet from the third network to the client to reach the client without shutting down the session, even when the portable network connection device is moved from the network, which the gateway device belongs to (second and third networks), to another network. This also enables at least a packet from the third network to the client to reach the client without shutting down the session, even when the portable network connection device is moved from another network to the network, which the gateway device belongs to.

According to the aspect of the network system, when the detector detects the absence of the portable network connection device in the second network, the path determiner determines a path from the first network to the third network as the forwarding path to forward a packet from the client to the third network.

The network system according to this aspect enables both a packet from the third network to the client and a packet from the client to the third network to be forwarded without shutting down the session, even when the portable network connection device is moved from the network, which the gateway device belongs to (second and third networks), to another network. The network system according to this aspect also enables both a packet from the third network to the client and a packet from the client to the third network to be forwarded without shutting down the session, even when the portable network connection device is moved from another network to the network, which the gateway device belongs to.

According to the aspect of the network system, the gateway device further includes a memory device that stores a first routing table and a second routing table, wherein
the first routing table that sets the path from the third network to the second network as the forwarding path to forward a packet from the third network to the client, and sets the path from the second network to the third network as the forwarding path to forward a packet from the client to the third network,
the second routing table wherein the path from the third network to the first network as the forwarding path to forward a packet from the third network to the client, and sets the path from the first network to the third network as the forwarding path to forward a packet from the client to the third network,

when the detector detects the presence of the portable network connection device in the second network, the path determiner refers to the first routing table to determine the forwarding path to forward a packet from the third network to the client and the forwarding path to forward a packet from the client to the third network, and

when the detector detects the absence of the portable network connection device in the second network, the path determiner refers to the second routing table to determine the forwarding path to forward a packet from the third network to the client and the forwarding path to forward a packet from the client to the third network.

The network system according to this aspect changes the routing table used for determination of a packet forwarding path, based on the presence or the absence of the portable network connection device in the second network, so as to prevent the session via the portable network connection device from being shut down. The network system of this aspect provides the first routing table and the second routing table and thereby shortens the time period required for determination of the packet forwarding path, compared with the configuration that rewrites the settings of one routing table, based on the presence or the absence of the portable network connection device in the second network.

According to the aspect of the network system, the tunnel path is provided by Mobile IP, and

when the detector detects the absence of the portable network connection device in the second network, the path determiner does not determine the forwarding path to forward a packet from the client to the third network.

This aspect allows tunneling by mobile IP, thus prevents the packet forwarded through the tunnel path from being intercepted by any third person.

According to the aspect of the network system, the portable network connection device further includes:
a notice packet sender that sends a notice packet to notify of the presence of the portable network connection device, and

the detector detects the presence or the absence of the portable network connection device in the second network, based on reception or non-reception of the notice packet via the fifth network interface.

The network system according to this aspect detects the presence of the portable network connection device in the second network on reception of the notice packet, while detecting the absence of the portable network connection device in the second network on non-reception of the notice packet. The presence or the absence of the portable network connection device in the second network can be detected accurately, based on the reception or no reception of the notice packet.

According to the aspect of the network system, the gateway device and the portable network connection device are both VRRP or Virtual Router Redundancy Protocol-convertible, and

the notice packet includes a packet representing a VRRP advertisement message by the VRRP protocol.

This configuration, wherein the gateway device and the portable network connection device cooperatively work as a VRRP virtual router, enables accurate detection of the presence or the absence of the portable network connection device in the second network. Additionally, according to this embodiment, the notice packet includes a packet representing a VRRP advertisement message. This simplifies the structure of the gateway device and reduces the manufacturing cost of the gateway device, compared with the configuration using an exclusive packet different from the packet representing the VRRP advertisement message.

According to the aspect of the network system, the gateway device further includes:
an address converter that converts IP address between a global IP address and a private IP address, wherein

the global IP addresses are assigned to the third network interface and the fourth network interface, and

the private IP address is assigned to the fifth network interface.

This aspect effectively prevents the session via the portable network connection device from being shut down, even when the portable network connection device and the client are moved from the network, which the gateway device belongs to, to another network while the client with assignment of a private IP address continues communication via the Internet.

According to an aspect of a gateway device that performs routing and is connectable with a portable network connection device, comprising:

an interface for a first network configured to connect with the first network including a tunnel path provided as a route through which a packet encapsulated with a header including a different destination address and a different source address different from a destination address and a source address specified by a source of the packet is forwarded;

an interface for a second network configured to connect with the second network that does not include the tunnel path;

an interface for a third network configured to connect with the third network that does not include the tunnel path and is different from the second network;

a detector that detects a presence or an absence of the portable network connection device in the second network;

a path determiner that determines a forwarding path to forward a packet, wherein
when the detector detects the presence of the portable network connection device in the second network, the path determiner determines a path from the third network to the second network as a forwarding path to forward a packet from the third network to a client connected with the portable network connection device, while determining a path from the second network to the third network as a forwarding path to forward a packet from the client to the third network, and
when the detector detects the absence of the portable network connection device in the second network, the path determiner determines a path from the third network to the first network as the forwarding path to forward a packet from the third network to the client;

a packet transfer controller configured to forward a packet through the determined path; and

an encapsulator configured to encapsulate a packet.

The gateway device according to the second aspect of the disclosure determines the path from the third network to the second network as the forwarding path to forward a packet from the third network to the client on detection of the presence of the portable network connection device in the second network, while determining the path from the third network to the first network as the forwarding path to forward a packet from the third network to the client on detection of the absence of the portable network connection device in the second network. This enables at least a packet from the third network to the client to reach the client without shutting down the session, even when the portable network connection device is moved from the network, which the gateway device belongs to (second and third networks), to another network. This also enables at least a packet from the third network to the client to reach the client without shutting down the session, even when the portable network connection device is moved from another network to the network, which the gateway device belongs to.

According to an aspect of a method of determining a forwarding path to forward a packet in a gateway device that performs routing and is connectable with a portable network connection device, wherein

the gateway device belongs to a first network, a second network and a third network wherein the first network includes a tunnel path provided as a route through which a packet encapsulated with a header including a different destination address and a different source address different from a destination address and a source address specified by a source of the packet is forwarded, the second network does not include the tunnel path, and the third network does not include the tunnel path and is different from the second network,

the method comprising:

detecting a presence or an absence of the portable network connection device in the second network;

when the presence of the portable network connection device in the second network is detected in the detecting, determining a path from the third network to the second network as a forwarding path to forward a packet from the third network to a client connected with the portable network connection device, while determining a path from the second network to the third network as a forwarding path to forward a packet from the client to the third network,

when the absence of the portable network connection device in the second network is detected in the detecting, determining a path from the third network to the first network as the forwarding path to forward a packet from the third network to the client.

The path determination method according to the third aspect of the disclosure determines the path from the third network to the second network as the forwarding path to forward a packet from the third network to the client on detection of the presence of the portable network connection device in the second network, while determining the path from the third network to the first network as the forwarding path to forward the packet from the third network to the client on detection of the absence of the portable network connection device in the second network. This enables at least a packet from the third network to the client to reach the client without shutting down the session, even when the portable network connection device is moved from the network, which the gateway device belongs to (second and third networks), to another network. This also enables at least the packet from the third network to the client to reach the client without shutting down the session, even when the portable network connection device is moved from another network to the network, which the gateway device belongs to.

According to the other aspect of the disclosure, there is provided a program executed to determine a forwarding path to forward a packet, in a gateway device configured to work as a router and arranged to be connectable with a portable network connection device. The gateway device belongs to a first network, a second network and a third network wherein the first network includes a tunnel path provided as a route, a packet encapsulated with a header including a different destination address and a different source address different from a destination address and a source address specified by a source of the packet is forwarded through the route, the second network does not include the tunnel path, and the third network does not include the tunnel path and is different from the second network. The program causes a computer included in the gateway device or the router to implement the functions of: detecting presence or absence of the portable network connection device in the second network; when presence of the portable network connection device in the second network is detected, determining a path from the third network to the second network as a forwarding path to forward a packet from the third network to a client connected with the portable network connection device, while determining a path from the second network to the third network as a forwarding path to forward a packet from the client to the third network, and when absence of the portable network connection device in the second network is detected, determining a path from the third network to the first network as the forwarding path to forward the packet from the third network to the client.

The program according to the aspect of the disclosure determines the path from the third network to the second network as the forwarding path to forward a packet from the third network to the client on detection of the presence of the portable network connection device in the second network, while determining the path from the third network to the first network as the forwarding path to forward a packet from the third network to the client on detection of the absence of the portable network connection device in the second network. This enables at least a packet from the third network to the client to reach the client without shutting down the session, even when the portable network connection device is moved from the network, which the gateway device belongs to (second and third networks), to another network. This also enables at least a packet from the third network to the client to reach the client without shutting down the session, even when the portable network connection device is moved from another network to the network, which the gateway device belongs to.

According to the aspect of the disclosure, there is provided a computer readable storage medium, in which the program according to the fourth aspect of the invention is recorded.

The non-transitory computer readable storage medium according to the aspect is used to make a computer read the program and implement the respective functions.

The present disclosure may be implemented by a variety of other aspects and applications, for example, a wireless relay device, a wireless communication system including the wireless relay device, control methods of the device or the system, computer programs to enable the functions of any of these methods, the device and the system, and non-transitory media in which such computer programs are stored.

What is claimed is:

1. A network system for forwarding a packet, comprising:
a portable network connection device that includes a first communication controller and is connectable with a client; and
a gateway device that includes a second communication controller and performs routing, wherein
the portable network connection device and the gateway device are connected by a first network including a tunnel path, wherein
when the portable network connection device and the gateway device are connected by a second network that does not include the tunnel path, the second communication controller communicates with the first communication controller via the second network, and
when the portable network connection device and the gateway device are not connected by the second network, the second communication controller communicates with the first communication controller via the first network.

2. The network system according to claim 1, wherein
the tunnel path is provided as a route through which a packet encapsulated with a header including a different destination address and a different source address different from a destination address and a source address specified by a source of the packet is forwarded,
the portable network connection device further includes:
a first network interface being connectable with the first network; and
a second network interface being connectable with the second network,
the first communication controller includes:
a first packet transfer processor configured to work as a bridge when the portable network connection device belongs to the second network, and to work as a router when the portable network connection device does not belong to the second network; and
a first encapsulator configured to encapsulate a packet,
the gateway device further includes:
a third network interface being connectable with a third network that does not include the tunnel path and is different from the second network;
a fourth network interface being connectable with the first network; and
a fifth network interface being connectable with the second network,
the second communication controller includes:
a detector that detects a presence or an absence of the portable network connection device in the second network;
a path determiner that determines a forwarding path to forward a packet, wherein when the detector detects the presence of the portable network connection device in the second network, the path determiner determines a path from the third network to the second network as a forwarding path to forward a packet from the third network to the client, while determining a path from the second network to the third network as a forwarding path to forward a packet from the client to the third network, and wherein when the detector detects the absence of the portable network connection device in the second network, the path determiner determines a path from the third network to the first network as the forwarding path to forward a packet from the third network to the client;
a second packet transfer controller configured to forward a packet along the determined path; and
a second encapsulator configured to encapsulate a packet.

3. The network system according to claim 2, wherein
when the detector detects the absence of the portable network connection device in the second network, the path determiner determines a path from the first network to the third network as the forwarding path to forward a packet from the client to the third network.

4. The network system according to claim 3, wherein
the gateway device further includes a memory device that stores a first routing table and a second routing table, wherein
the first routing table that sets the path from the third network to the second network as the forwarding path to forward a packet from the third network to the client, and sets the path from the second network to the third network as the forwarding path to forward a packet from the client to the third network,
the second routing table wherein the path from the third network to the first network as the forwarding path to forward a packet from the third network to the client, and sets the path from the first network to the third network as the forwarding path to forward a packet from the client to the third network,
when the detector detects the presence of the portable network connection device in the second network, the path determiner refers to the first routing table to determine the forwarding path to forward a packet from the third network to the client and the forwarding path to forward a packet from the client to the third network, and
when the detector detects the absence of the portable network connection device in the second network, the path determiner refers to the second routing table to determine the forwarding path to forward a packet from the third network to the client and the forwarding path to forward a packet from the client to the third network.

5. The network system according to claim 2, wherein
the tunnel path is provided by Mobile IP, and
when the detector detects the absence of the portable network connection device in the second network, the path determiner does not determine the forwarding path to forward a packet from the client to the third network.

6. The network system according to claim 2, wherein
the portable network connection device further includes:
a notice packet sender that sends a notice packet to notify of the presence of the portable network connection device, and
the detector detects the presence or the absence of the portable network connection device in the second network, based on reception or non-reception of the notice packet via the fifth network interface.

7. The network system according to claim 6, wherein
the gateway device and the portable network connection device are both VRRP or Virtual Router Redundancy Protocol-convertible, and
the notice packet includes a packet representing a VRRP advertisement message by the VRRP protocol.

8. The network system according to claim 2, wherein
the gateway device further includes:
an address converter that converts IP address between a global IP address and a private IP address, wherein
the global IP addresses are assigned to the third network interface and the fourth network interface, and
the private IP address is assigned to the fifth network interface.

9. A gateway device that performs routing and is connectable with a portable network connection device, comprising:
an interface for a first network configured to connect with the first network including a tunnel path provided as a route through which a packet encapsulated with a header including a different destination address and a different source address different from a destination address and a source address specified by a source of the packet is forwarded;
an interface for a second network configured to connect with the second network that does not include the tunnel path;
an interface for a third network configured to connect with the third network that does not include the tunnel path and is different from the second network;
a detector that detects a presence or an absence of the portable network connection device in the second network;
a path determiner that determines a forwarding path to forward a packet, wherein
when the detector detects the presence of the portable network connection device in the second network, the path determiner determines a path from the third network to the second network as a forwarding path to forward a packet from the third network to a client connected with the portable network connection device, while determining a path from the second network to the third network as a forwarding path to forward a packet from the client to the third network, and
when the detector detects the absence of the portable network connection device in the second network, the path determiner determines a path from the third network to the first network as the forwarding path to forward a packet from the third network to the client;
a packet transfer controller configured to forward a packet through the determined path; and
an encapsulator configured to encapsulate a packet.

10. The gateway device according to claim 9, wherein
when the detector detects the absence of the portable network connection device in the second network, the path determiner determines a path from the first network to the third network as the forwarding path to forward a packet from the client to the third network.

11. The gateway device according to claim 10, further comprises a memory device that stores a first routing table and a second routing table, wherein
the first routing table sets the path from the third network to the second network as the forwarding path to forward a packet from the third network to the client, and sets the path from the second network to the third network as the forwarding path to forward a packet from the client to the third network,
the second routing table sets the path from the third network to the first network as the forwarding path to forward a packet from the third network to the client, and sets the path from the first network to the third network as the forwarding path to forward a packet from the client to the third network,
when the detector detects the presence of the portable network connection device in the second network, the path determiner refers to the first routing table to determine the forwarding path to forward a packet from the third network to the client and the forwarding path to forward a packet from the client to the third network, and
when the detector detects the absence of the portable network connection device in the second network, the path determiner refers to the second routing table to determine the forwarding path to forward a packet from the third network to the client and the forwarding path to forward a packet from the client to the third network.

12. The gateway device according to claim 9, wherein
the tunnel path is provided by Mobile IP, and
when the detector detects the absence of the portable network connection device in the second network, the path determiner does not determine the forwarding path to forward a packet from the client to the third network.

13. The gateway device according to claim 9 wherein
the portable network connection device further includes:
a notice packet sender that sends a notice packet to notify of the presence of the portable network connection device, and
the detector detects the presence or the absence of the portable network connection device in the second network, based on reception or non-reception of the notice packet via the second network interface.

14. The gateway device according to claim 13, wherein
the gateway device and the portable network connection device are both VRRP or Virtual Router Redundancy Protocol-convertible, and
the notice packet includes a packet representing a VRRP advertisement message by the VRRP protocol.

15. The gateway device according to claim 9, further comprising:
an address converter that converts IP address between a global IP address and a private IP address, wherein
the global IP addresses are assigned to the interface for the first network and the interface for the third network, and
the private IP address is assigned to the interface for the second network.

16. A method of determining a forwarding path to forward a packet in a gateway device that performs routing and is connectable with a portable network connection device, wherein
the gateway device belongs to a first network, a second network and a third network wherein the first network includes a tunnel path provided as a route through which a packet encapsulated with a header including a different destination address and a different source address different from a destination address and a source address specified by a source of the packet is forwarded, the second network does not include the tunnel path, and the third network does not include the tunnel path and is different from the second network,
the method comprising:
detecting a presence or an absence of the portable network connection device in the second network;
when the presence of the portable network connection device in the second network is detected in the detecting, determining a path from the third network to the second network as a forwarding path to forward a packet from the third network to a client connected with the portable network connection device, while determining a path from the second network to the third network as a forwarding path to forward a packet from the client to the third network,
when the absence of the portable network connection device in the second network is detected in the detecting, determining a path from the third network to the first network as the forwarding path to forward a packet from the third network to the client.

17. The method according to claim 16, wherein
when the absence of the portable network connection device in the second network is detected in the detecting, the determining determines a path from the first network to the third network as the forwarding path to forward a packet from the client to the third network.

18. The method according to claim 17, wherein
when the presence of the portable network connection device in the second network is detected in the detecting, the determining refers to a first routing table to determine the forwarding path to forward a packet from the third network to the client and the forwarding path to forward a packet from the client to the third network, wherein the first routing table is stored in a memory device included in the gateway device, the first routing table sets the path from the third network to the second network as the forwarding path to forward a packet from the third network to the client, and sets the path from the second network to the third network as the forwarding path to forward a packet from the client to the third network, and
when the absence of the portable network connection device in the second network is detected in the detecting, the determining refers to a second routing table to determine the forwarding path to forward a packet from the third network to the client and the forwarding path to forward a packet from the client to the third network, the second routing table is stored in a memory device included in the gateway device, the second routing table wherein the path from the third network to the first network is set as the forwarding path to forward a packet from the third network to the client, and the path from the first network to the third network is set as the forwarding path to forward a packet from the client to the third network.

19. The method according to claim 16, wherein
the tunnel path is provided by Mobile IP, and
when the absence of the portable network connection device in the second network is detected in the detecting, the determining does not determine the forwarding path to forward a packet from the client to the third network.

20. The method according to claim 16, wherein
the portable network connection device sends a notice packet to notify of the presence of the portable network connection device, and
the detecting detects the presence or the absence of the portable network connection device in the second network, based on reception or non-reception of the notice packet via the fifth network interface.

21. The method according to claim 20, wherein
the gateway device and the portable network connection device are both VRRP or Virtual Router Redundancy Protocol-convertible, and
the notice packet includes a packet representing a VRRP advertisement message by the VRRP protocol.
